(19) United States
(12) Patent Application Publication
(10) Pub. No.: US 2018/0202216 A1
(43) Pub. Date: Jul. 19, 2018

(54) WINDOW DRIVE APPARATUS AND VEHICLE DOOR USING THE SAME

(71) Applicant: Johnson Electric S.A., Murten (CH)

(72) Inventors: Jingning TA, Hong Kong (CN); Yue LI, Hong Kong (CN); Jingxin SHI, Shenzhen (CN); Yongjun ZHAO, Shenzhen (CN); Junmao FU, Shenzhen (CN); Qiumei LI, Shenzhen (CN)

(21) Appl. No.: 15/868,472

(22) Filed: Jan. 11, 2018

(30) Foreign Application Priority Data
Jan. 16, 2017 (CN) 2017 1002 9027.7

(51) Int. Cl. E05F 15/697; F16H 1/20

(52) U.S. Cl. CPC E05F 15/697; E05Y 2900/55; F16H 1/206

(57) ABSTRACT

A window drive apparatus includes an electric motor and a gear train. The gear train includes a first deceleration mechanism and a second deceleration mechanism. The first deceleration mechanism includes a worm driven by the electric motor and a worm gear meshed with the worm. The second deceleration mechanism includes a first driving gear and a second driving gear coaxially fixed and respectively located at opposite sides of the worm gear, a first driven gear meshed with the first driving gear and a second driven gear meshed with the second driving gear. The first driven gear and the second driven gear are coaxially fixed together. A vehicle door including the window drive apparatus is also provided.

### CROSS REFERENCE TO RELATED APPLICATIONS

This non-provisional patent application claims priority under 35 U.S.C. § 119(a) from Patent Application No. 201710029027.7 filed in The People's Republic of China on Jan. 16, 2017.

### FIELD OF THE INVENTION

The present invention relates to the field of vehicle doors, and in particular to a window drive apparatus including an electric motor and a gear train, and a vehicle door employing the window drive apparatus.

### BACKGROUND OF THE INVENTION

A vehicle door usually comprises an outer wall, an inner wall, a window glass and a window drive apparatus. The window glass is movably installed between the outer wall and the inner wall. The window drive apparatus is installed between the outer wall and the inner wall for lifting and lowering the window glass. The vehicle door has a limited thickness which requires the volume of the window drive apparatus is as small as possible. A traditional window drive apparatus has a reduction ratio of around 75 which is not big enough.

### SUMMARY OF THE INVENTION

Thus, there is a desire for a window drive apparatus with an increased reduction ratio.

In one aspect, the present disclosure provides a window drive apparatus which includes an electric motor and a gear train. The gear train includes a first deceleration mechanism and a second deceleration mechanism. The first deceleration mechanism comprises a worm driven by the electric motor and a worm gear meshed with the worm. The second deceleration mechanism comprises a first driving gear and a second driving gear coaxially fixed and respectively located at opposite sides of the worm gear, a first driven gear meshed with the first driving gear and a second driven gear meshed with the second driving gear. The first driven gear and the second driven gear are coaxially fixed together.

Preferably, outer diameters of the first driving gear and the second driving gear are both less than that of the worm gear, and a receiving space is defined between the first driven gear and the second driven gear for receiving a radial external portion of the worm gear.

Preferably, a distance between two surfaces of the first driving gear and the second driving gear opposing from each other is equal to or slightly greater than a distance between two surfaces of the first driven gear and the second driven gear opposing from each other.

Preferably, the worm is coaxially fixed to a first rotation axle, the motor comprises an output shaft, the first rotation axle and the output shaft of the motor are separately formed and coaxially connected together, and the first rotation axle is supported by a bearing which is located between the worm and the electric motor.

In another aspect, the gear train further comprises an output wheel which is coaxially fixed with the first driven gear.

Preferably, the output wheel is positioned to the first driven gear via a positioning projection engaged in a positioning slot.

Preferably, a height of the gear train is substantially equal to a thickness of the motor.

Preferably, the electric motor is a single phase motor.

In another aspect, the present disclosure provides a vehicle door which includes an outer wall, an inner wall, a window glass and a window drive apparatus. The window glass and the window drive apparatus are installed in a space defined between the outer wall and the inner wall. The window drive apparatus includes an electric motor and a gear train. The gear train includes a first deceleration mechanism configured to decelerate an output speed of the electric motor and a second deceleration mechanism configured to decelerate an output speed of the first deceleration mechanism, the electric motor drives the window glass to move via the first and second deceleration mechanism.

Preferably, the gear train has a reduction ratio greater than 90.

Preferably, the electric motor is a single phase motor.

Preferably, the first deceleration mechanism comprises a worm driven by the electric motor and a worm gear meshed with the worm, and the second deceleration mechanism comprises a first driving gear, a second driving gear, a first driven gear meshed with the first driving gear and a second driven gear meshed with the second driving gear, the first driving gear and the second driving gear are coaxially fixed together and located at opposite sides of the worm gear, the first driven gear and the second driven gear are coaxially fixed together.

Preferably, outer diameters of the first driving gear and the second driving gear are both less than that of the worm gear, and a receiving space is defined between the first driven gear and the second driven gear for receiving a radial external portion of the worm gear.

Preferably, a distance between two surfaces of the first driving gear and the second driving gear opposing from each other is equal to or slightly greater than a distance between two surfaces of the first driven gear and the second driven gear opposing from each other.

Preferably, the gear train further comprises an output wheel which is coaxially fixed with the first driven gear.

Preferably, a height of the gear train is substantially equal to a thickness of the motor.

The gear train of the window drive apparatus of the present disclosure has two stages deceleration mechanism and thus has an increased reduction ratio.

### BRIEF DESCRIPTION OF THE DRAWINGS

FIG. 1 is a schematic view of a vehicle door according to one embodiment of the present invention.

FIG. 2 is a cross sectional view of the vehicle door of FIG. 1 taken along the line A-A thereof.

FIG. 3 is a side plane view of a window drive apparatus used in the vehicle door of FIG. 2.

FIG. 4 is a perspective view of the window drive apparatus of FIG. 3.

FIG. 5 is similar to FIG. 4 but with a cover of a casing of a gear train of the window drive apparatus removed.

FIG. 6 illustrates the first and second deceleration mechanisms of the gear train of FIG. 5.

FIG. 7 is a top view of a worm gear, a first driving gear and a second driving gear of FIG. 6.

FIG. 8 is a cross section view of the components of FIG. 7, taken along the line B-B.

FIG. 9 is an exploded view of the components of FIG. 8.

FIG. 10 is a top view of a first driven gear, a second driven gear, a second mounting shaft and an output wheel of FIG. 6.

FIG. 11 is a cross section view of the components of FIG. 10, taken along the line C-C.

FIG. 12 is an exploded view of the components of FIG. 10.

### DETAILED DESCRIPTION OF THE PREFERRED EMBODIMENTS

Below, embodiments of the present invention will be described in greater detail with reference to the drawings. Elements of similar structures or functions are generally represented by like reference numerals for illustrative purposes throughout the figures. It should be noted that the figures are illustrative rather than limiting. The figures are not drawn to scale, do not illustrate every aspect of the described embodiments, and do not limit the scope of the present disclosure. Unless otherwise specified, all technical and scientific terms used in this disclosure have the ordinary meaning as commonly understood by people skilled in the art.

Refer to FIG. 1, a vehicle door 200 in accordance with an embodiment of the present invention comprises a door frame 210, and a window glass 220 movably mounted to the door frame 210.

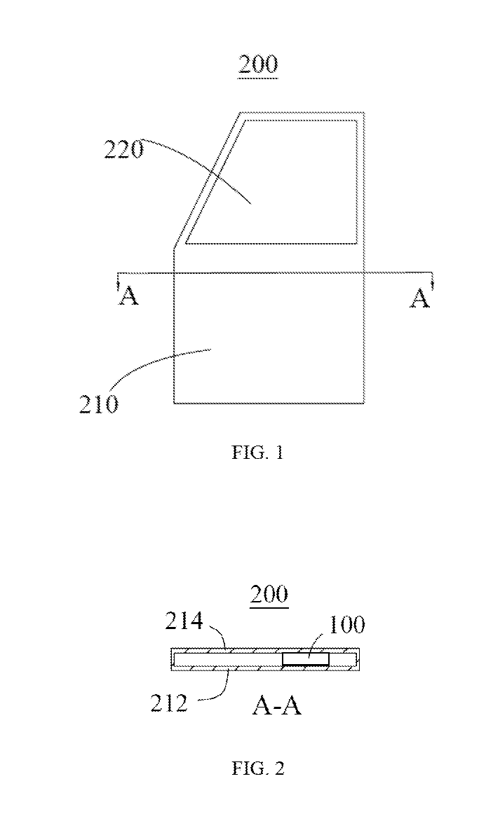

Refer to FIG. 2, the door frame 210 includes an outer wall 212 and an inner wall 214. A space is defined between the outer wall 212 and the inner wall 214 for installing a window drive apparatus 100 therein. The window drive apparatus 100 is configured to drive the window glass 220 to move up and down relative to the door frame 210.

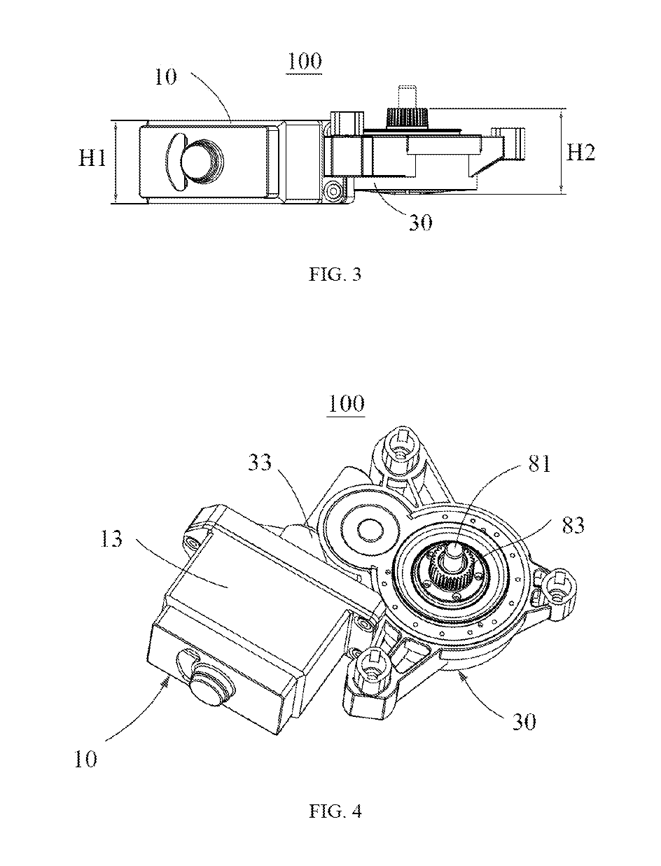

Refer to FIG. 3, the window drive apparatus 100 includes an electric motor 10 and a gear train 30. The gear train 30 is connected to the output end of the motor 10, for decelerating the output speed of the motor 10 and increasing the output torque of the motor 10. The motor 10 and the gear train 30 both are installed in the space between the outer wall 212 and the inner wall 214 of the door frame 210. Preferably, the height H2 of the main body of the gear train 30 is substantially equal to the thickness H1 of the motor 10. In this embodiment, the height H2 and the thickness H1 are measured in a direction perpendicular to the outer wall 212 and the inner wall 214 of the door frame 210. Preferably, the main body of the gear train 30 is better to level with the motor 10. Compared to traditional window drive apparatus where the gear train is much higher than the motor, the window drive apparatus 100 of the present invention wherein the height of the gear train 30 is close to the thickness of the motor 10, occupies a much less volume.

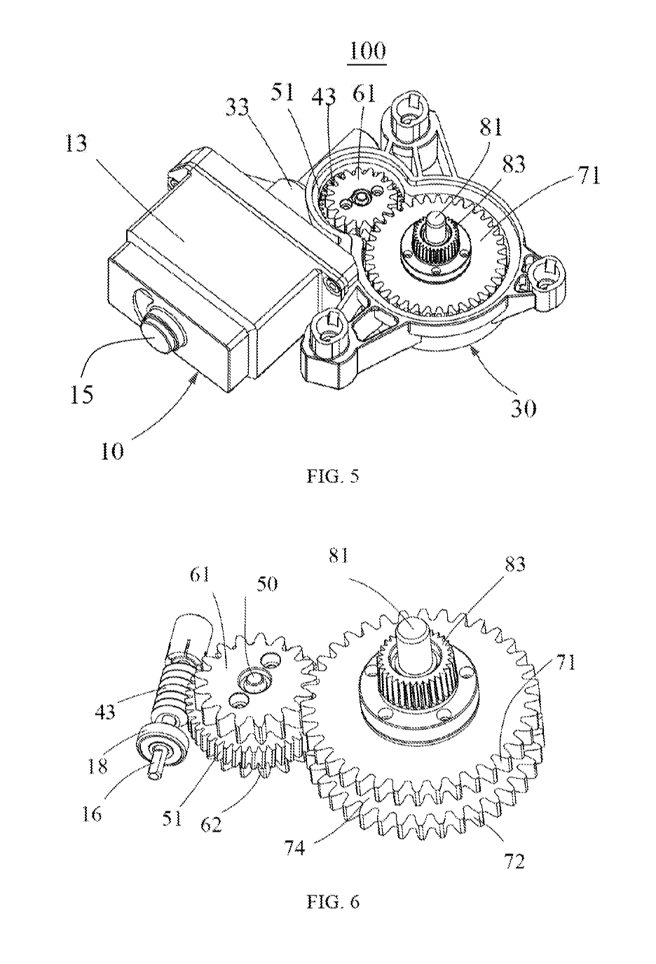

Refer to FIG. 4 to FIG. 6, a casing 33 of the gear train 30 is connected with a housing 13 of the motor 10. A first mounting shaft 50 and a second mounting shaft 81 are mounted in the casing 33. The gear train 30 includes a first deceleration mechanism and a second deceleration mechanism. The first deceleration mechanism includes a worm 43 and a worm gear 51. The second deceleration mechanism includes a first driving gear 61, a second driving gear 62, a first driven gear 71 and a second driven gear 72. The gear train 30 further comprises an output wheel 83.

The worm 43 is coaxially fixed to a first rotation axle 16 and is rotatable together with the first rotation axle 16. In this embodiment, the first rotation axle 16 and an output shaft 15 of the motor 10 are separately formed and coaxially connected together. The worm 43 is fixedly mounted around the first rotation axle 16. Alternatively, the worm 43 may be integrally formed with the first rotation axle 16 or connected to the first rotation axle 16 through a connecting part. The first rotation axle 16 may be a part of the output shaft 15 of the motor 10. In all alternative embodiments, the worm 43 is rotatable with the output shaft 15 of the motor 10 coaxially and synchronously.

The worm gear 51 is mounted around the first mounting shaft 50 and is rotatable relative to the casing 33 of the gear train 30. The worm gear 51 is meshed with the worm 43, and the number of teeth of the worm gear 51 is greater than the number of the starts of the worm 43. The first driving gear 61 and the second driving gear 62 are mounted around the first mounting shaft 50 and respectively fixed to opposite axial sides of the worm gear 51, and are rotatable together with the worm gear 51. The outer diameters and teeth numbers of the first driving gear 61 and the second driving gear 62 are less than the outer diameter and the teeth number of the worm gear 51.

The first driven gear 71 and the second driven gear 72 are rotatably mounted in the gear train 30 through the second mounting shaft 81. The first driven gear 71 and the second driven gear 72 are coaxially fixed with each other and meshed with the first driving gear 61 and the second driving gear 62 respectively. The number of the teeth of the driven gear 71 is greater than that of the driving gear 61, and the number of the teeth of the driven gear 72 is greater than that of the driving gear 62. The output wheel 83 is mounted around the second mounting shaft 81 and coaxially fixed with the first driven gear 71 and the second driven gear 72. The outer diameter of the output wheel 83 is less than that of the first driven gear 71 and the second driven gear 72.

In this embodiment, the gear train 30 employs two stages deceleration mechanisms and thus has an increased reduction ratio. Preferably, the reduction ratio of the gear train 30 is bigger than 90. In this embodiment, the reduction ratio of the gear train 30 is in the range from 90 to 120.

Preferably, the electric motor 10 is a single phase motor which has the characteristics of low cost, small volume, light weight, low noise and high output speed. The single phase motor 30 cooperates with the gear train 30 with a high reduction ratio, which can meet the requirement of the window drive apparatus. In this embodiment, the single phase motor 10 is a single phase brushless direct current motor.

Preferably, the tooth pitch of the first driving gear 61 is equal to that of the second driving gear 62 and the tooth pitch of the first driven wheel 71 is equal to that of the second driven wheel 72. The tooth pitches of the driving gears 61, 62 and driven gears 71, 72 are all larger than that of the worm gear 51. Via using dual driving gears 61 and 62 and dual driven gears 71 and 72, the gear train 30 can realize dual side output, which can reduce the axial size (also known as the height of the gear train) of the gear train 30 but keep a high reduction ratio without increasing the thickness significantly.

Preferably, the outer diameter and the teeth number of the first driving gear 61 are equal to that of the second driving gear 62. The outer diameter and the teeth number of the first driven gear 71 are equal to that of the second driven gear 72. Thus, an symmetric structure is arranged at opposite sides of the worm gear 51 in order to keep the stability of transmission.

Preferably, the first driven gear 71 and the second driven gear 72 are symmetrically distributed at opposite sides of the worm gear 51. A space 74 is defined between the first driven gear 71 and the second driven gear 72 for receiving a radial external portion of the worm gear 51, in order to avoid mechanical interference between the driven gears 71, 72 and the worm gear 51.

Preferably, the first rotation axle 16 is supported by a bearing 18 located between the worm 43 and the motor 10, to increase the bearing capacity of the first rotational axle 16.

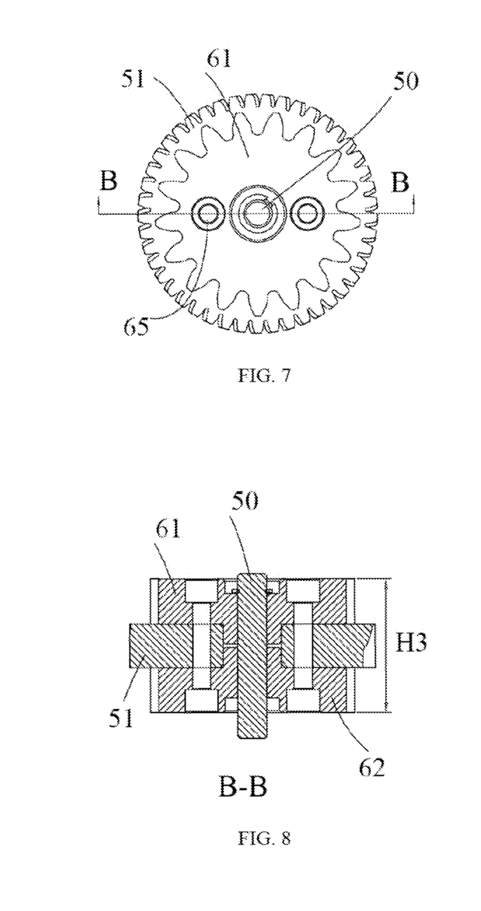

Preferably, the distance H3 (see FIG. 8) between two surfaces of the first driving gear 61 and the second driving gear 62 opposing from each other is equal to or slightly greater than the distance H4 (see FIG. 11) between two surfaces of the first driven gear 71 and the second driven gear 72 opposing from each other.

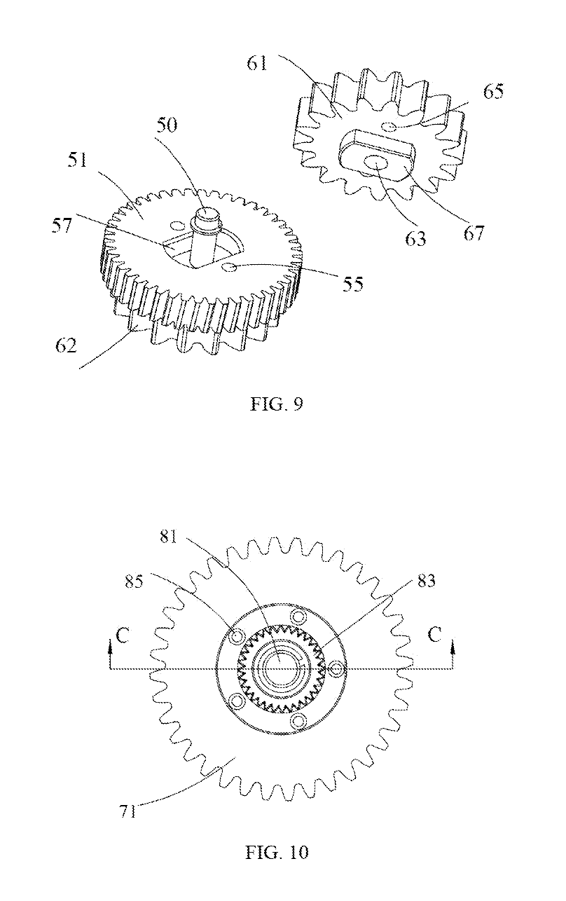

Refer to FIG. 7 to FIG. 9, the first driving gear 61, the second driving gear 62 and the worm gear 51 are separately formed and then fixed together to form an integral structure. Each of the first and second driving gears 61, 62 is positioned to the worm gear 51 through a positioning projection engaged in a positioning slot. In particular, the center of the worm gear 51 defines a positioning hole 57. The first driving gear 61 forms a corresponding positioning projection 67 received or engaged in the positioning hole 57 to thereby cause the first driving gear 61 to be rotatable together with the worm gear 51 synchronously. Preferably, the positioning projection 67 has a configuration conformed to that of the positioning hole 57. Preferably, the positioning projection 67 has a substantially rectangular cross section. The structure of the second driving gear 62 is similar to that of the first driving gear 61 and detailed description of the second driving gear 62 is thus omitted. Preferably, the positioning hole 57 is a through hole for passing through of the first mounting shaft 50. The first driving gear 61 defines a central through hole 63 for extension of the first mounting shaft 50. In addition, the first driving gear 61, the second driving gear 62 and the worm gear 51 may be fixed together through axial connecting members. Specifically, the first driving gear 61 and the second driving gear 62 define through holes 65, and the worm gear 51 defines corresponding through holes 55. The axial connecting members for example screws extend through the through holes to thereby fasten the first and second driving gears 61, 62 to opposite sides of the worm gear 51. Alternatively, the first driving gear 61, the second driving gear 62 and the worm gear 51 may be integrally formed as a single integral structure.

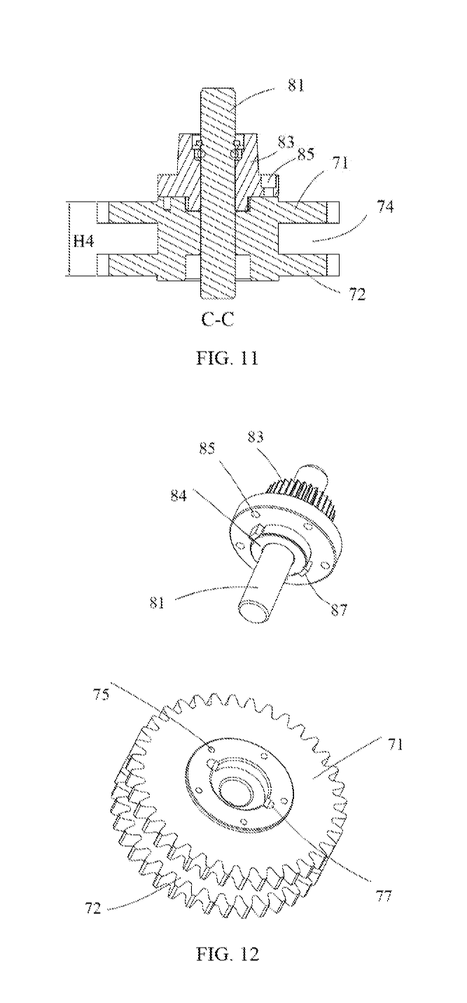

Refer to FIG. 10 to FIG. 12, the first driven gear 71 and the second driven gear 72 are integrally formed as a single integral structure. The output wheel 83 is coaxially fixed with the first driven gear 71. The output wheel 83 is position to the first driven gear 71 through a positioning projection engaged in a positioning slot. In particular, the first driven gear 71 defines a recess with a pair of positioning slots 77 at opposite sides of the recess, and the bottom of the output wheel 83 forms a connection seat 84 with a pair of positioning projections 87. The connection seat 84 of output wheel 83 is received in the recess of the driven gear 71 and the positioning projections 87 are respectively engaged in the positioning slots 77 such that the output wheel 83 is rotatable together with the first driven gear 71 synchronously. Understandably, the locations of the positioning projections 87 and the positioning slots 77 are interchangeable. Similarly, the output wheel 83 and the first driven gear 71 defines connecting holes 85, 75 respectively. The output wheel 83 and the first driven gear 71 may be fixed together through axial connecting memberings for example screws respectively extending through the corresponding connecting holes. In at least one embodiment, the output wheel 83 may be in splined connection with a component in the door frame 210 with internal splines, to transmit torque.

Therefore, the technical solutions of embodiments of the present invention have been clearly and completely described above. Apparently, the described embodiments are merely part of, rather than all of, the embodiments of the present invention. A person skilled in the art may make various combinations of technical features in the various embodiments to meet practical needs. Based on the described embodiments of the present invention, any other embodiment obtained by a person skilled in the art without paying creative efforts shall also fall within the scope of the present invention.

1. A window drive apparatus comprising:
an electric motor; and
a gear train comprising a first deceleration mechanism and a second deceleration mechanism, wherein the first deceleration mechanism comprises a worm driven by the electric motor and a worm gear meshed with the worm, the second deceleration mechanism comprises a first driving gear and a second driving gear coaxially fixed and respectively located at opposite sides of the worm gear, a first driven gear meshed with the first driving gear and a second driven gear meshed with the second driving gear, the first driven gear and the second driven gear are coaxially fixed together.

2. The window drive apparatus of claim 1, wherein outer diameters of the first driving gear and the second driving gear are both less than that of the worm gear, and a receiving space is defined between the first driven gear and the second driven gear for receiving a radial external portion of the worm gear.

3. The window drive apparatus of claim 1, wherein a distance between two surfaces of the first driving gear and the second driving gear opposing from each other is equal to or slightly greater than a distance between two surfaces of the first driven gear and the second driven gear opposing from each other.

4. The window drive apparatus of claim 1, wherein the worm is coaxially fixed to a first rotation axle, the motor comprises an output shaft, the first rotation axle and the output shaft of the motor are separately formed and coaxially connected together, and the first rotation axle is supported by a bearing which is located between the worm and the electric motor.

5. The window drive apparatus of claim 1, wherein the gear train further comprises an output wheel which is coaxially fixed with the first driven gear.

6. The window drive apparatus of claim 5, wherein the output wheel is positioned to the first driven gear via a positioning projection engaged in a positioning slot.

7. The window drive apparatus of claim 1, wherein a height of the gear train is substantially equal to a thickness of the motor.

8. The window drive apparatus of claim 1, wherein the electric motor is a single phase motor.

9. A vehicle door comprising:
an outer wall;
an inner wall;
a window glass installed in a space defined between the outer wall and the inner wall; and
a window drive apparatus received in the space between the outer wall and the inner wall, the window drive apparatus comprising:
an electric motor; and
a gear train comprising a first deceleration mechanism configured to decelerate an output speed of the electric motor and a second deceleration mechanism configured to decelerate an output speed of the first deceleration mechanism, wherein the electric motor drives the window glass to move via the first and second deceleration mechanisms.

10. The vehicle door of claim 9, wherein the gear train has a reduction ratio greater than 90.

11. The vehicle door of claim 9, wherein the electric motor is a single phase motor.

12. The vehicle door of claim 9, wherein the first deceleration mechanism comprises a worm driven by the electric motor and a worm gear meshed with the worm, and the second deceleration mechanism comprises a first driving gear, a second driving gear, a first driven gear meshed with the first driving gear and a second driven gear meshed with the second driving gear, the first driving gear and the second driving gear are coaxially fixed together and located at opposite sides of the worm gear, the first driven gear and the second driven gear are coaxially fixed together.

13. The vehicle door of claim 12, wherein outer diameters of the first driving gear and the second driving gear are both less than that of the worm gear, and a receiving space is defined between the first driven gear and the second driven gear for receiving a radial external portion of the worm gear.

14. The vehicle door of claim 12, wherein a distance between two surfaces of the first driving gear and the second driving gear opposing from each other is equal to or slightly greater than a distance between two surfaces of the first driven gear and the second driven gear opposing from each other.

15. The vehicle door of claim 12, wherein the gear train further comprises an output wheel which is coaxially fixed with the first driven gear.

16. The vehicle door of claim 12, wherein a height of the gear train is substantially equal to a thickness of the motor.
